(19) United States
(12) Patent Application Publication
(10) Pub. No.: US 2008/0278948 A1
(43) Pub. Date: Nov. 13, 2008

(54) Dancing Decorative Lamp

(76) Inventor: Xuliang Li, Dongguan (CN)

Correspondence Address: GLOBAL IP SERVICES, 7285 W. Eagle Court, Winton, CA, 95388, US

(21) Appl. No.: 11/830,134

(22) Filed: Jul. 30, 2007

(30) Foreign Application Priority Data
May 8, 2007 (CN) 200720119889.0

(51) Int. Cl. F21S 13/14

(52) U.S. Cl. 362/252

(57) ABSTRACT

The present invention relates to a decorative lamp, and more particularly to a decorative lamp that can generate dancing effect. The dancing decorative lamp comprises string-lights, a pedestal, and a support in a certain shape, the string-lights are mounted on the support; said support comprises at least one main support which asway connects to the pedestal by the elastic component; said support at least comprises one auxiliary support which asway connects to the main support with the elastic component. The present invention provides a dancing decorative lamp that can generate dancing effect.

### CROSS REFERENCE TO RELATED PATENT APPLICATION

This patent application claims the priority of the Chinese patent application No. 200720119889.0, filing date of May 8, 2007.

### FIELD OF THE INVENTION

The present invention relates to a decorative lamp, and more particularly to a decorative lamp which can generate dancing effective.

### BACKGROUND OF THE INVENTION

Chinese patent 97231987.5 publishes a strip-assembled framework model. The model consists of a plurality of strips (such as iron, plastics, etc.). Various shapes of vivid animal model can be made after the strips are distorted, assembled and welded. A shining animal model can be seen at night after setting a number of festival lights along the strips, which increases the festival atmosphere. However, this festival decorative lamp model has a disadvantage of lacking dancing effect. Setting driven devices like electromotor or clockwork spring can settle the problem, but it will cause higher cost. Furthermore, these devices will soon be unavailable under solarization and drencher while these lamps are always put in an opened air environment.

### SUMMARY OF THE INVENTION

Accordingly, an object of the present invention is to provide a dancing decorative lamp which can have dancing effect.

To achieve the above-mentioned object, the present invention comprises:

A dancing decorative lamp, comprising: string-lights, a pedestal, and a support in a certain shape, the string-lights are mounted on the support; said support comprises at least one main support which asway connects to the pedestal with an elastic component; said support also comprises at least one auxiliary support asway connects to the main support with an elastic component

Preferably, said support comprises a main support in the shape of snowman and two auxiliary supports in the shape of arm.

Preferably, the elastic component comprises at least one of the following components: screwy spring, shrapnel, elastic steel wire, rubber strip and elastic plastic rob.

Preferably, the string-lights are LED string-lights bound on the support.

In the present invention, the main support of the dancing decorative lamp aswag connects to the pedestal with an elastic component, and the auxiliary support asway connects to the main support with an elastic component. The main support and the auxiliary support together form the figuration of the dancing decorative lamp. The whole decorative lamp rocks ceaselessly when breeze blows. And with the sprinkle of the string-lights, the lamp will generate dancing effect which can't be simulated by manual work.

### BRIEF DESCRIPTION OF THE DRAWINGS

FIG. 1 is a perspective view of a dancing decorative lamp according to the present invention.

### DETAILED DESCRIPTION OF ILLUSTRATED EMBODIMENTS

A preferred embodiment of the present invention will now be described.

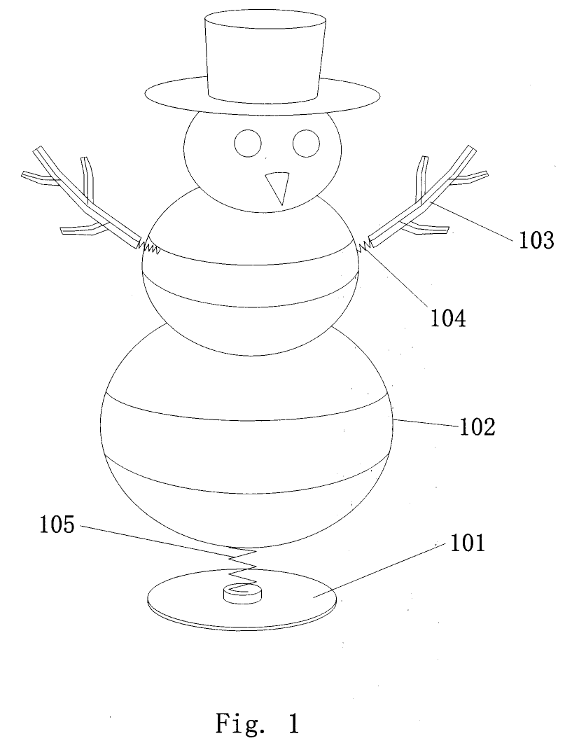

As indicated above, the present invention is directed to a dancing decorative lamp in the shape of snowman comprising LED string-lights (LED string-lights bound on the support are omitted in the FIG. 1 in order to express the connection of the support more distinctly.), a pedestal 101 and the support in the shape of snowman, the string-lights are mounted on the support; the support comprises a main support 102, which asway connects to the pedestal 101 with a screwy spring 105; the support comprises two auxiliary supports 103, which asway connect to the main support 102 with screwy springs 104. The main support 102 makes the body of the snowman, while the two auxiliary supports make the arms of the snowman.

In the dancing decorative lamp that the present invention related to, the body of the snowman connects to the pedestal with the spring screwy spring 105, while it also connects to the two arms of the snowman by the screwy springs 104. The whole decorative lamp rocks ceaselessly when breeze blows. And with the sprinkle of the string-lights, the lamp will generate dancing effect which can't be simulated by manual work.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the invention.

1. A dancing decorative lamp comprising: string-lights, a pedestal and a support in a certain shape, string-lights being mounted on said support; said support comprising at least one main support which elastically connecting to said pedestal with an elastic component; said support at least comprising an auxiliary support which elastically connecting to said main support with an elastic component.

2. The dancing decorative lamp according to claim 1, wherein said support comprises a main support in the shape of snowman and two auxiliary supports in the shape of arm.

3. The dancing decorative lamp according to claim 1, wherein said elastic component comprises at least one of the following components: screwy spring, shrapnel, elastic steel wire, rubber strip and elastic plastic rob.

4. The dancing decorative lamp according to claim 1, wherein said string-lights are LED string-lights bound on the support.
